(19) United States
(12) Patent Application Publication
(10) Pub. No.: US 2009/0206077 A1
(43) Pub. Date: Aug. 20, 2009

(54) Protective Camera Enclosure

(75) Inventors: Bradley S. Melmon, Seattle, WA (US); Ryan H. Mongan, Sammamish, WA (US); David J. Law, Seattle, WA (US); Parker T. Chou, Seattle, WA (US); Graeme Esarey, Seattle, WA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: Daymen Photo Marketing LP, A Canadian Limited Partnership, Sebastopol, CA (US)

(21) Appl. No.: 12/235,487

(22) Filed: Sep. 22, 2008

Related U.S. Application Data
(60) Provisional application No. 61/065,855, filed on Feb. 19, 2008.

(51) Int. Cl. G03B 19/18; G03B 19/00

(52) U.S. Cl. 220/4.02; 396/535

(57) ABSTRACT

The invention relates generally to a protective enclosure for electronic devices, for example, optical devices such as cameras. More specifically, the present invention is a protective enclosure featuring a customized hard or semi-hard front and rear shells for the camera body. The two components are attached at one end by a hinge and secured at the other end by a latch. An elastomeric skin, which can cover some or all of the camera body, serves a gasket between the front and rear shell. The lens is protected by customized enclosures made of elastomeric, and hard or semi-hard materials.

### CROSS REFERENCE TO PRIORITY AND RELATED APPLICATIONS

This application claims priority benefit to provisional application, U.S. Application No.: 61/065,855, filed Feb. 19, 2008, entitled “Protective Camera Enclosure.”

This application is related to the following co-pending applications, with some common inventors, and the same assignee. The teachings of the following applications listed below are herein incorporated by reference:

U.S. application Ser. No.: 11/695,625, filed Apr. 3, 2007, entitled “Skin Cover for Cameras.”

U.S. application Ser. No.: 11/772,210, filed Jun. 30, 2007, entitled “Weatherproofing Apparatus and Method for Cameras and Video Recorders.”

U.S. application Ser. No.: not yet assigned, filed Sep. 22, 2008, entitled “Protective Transport Bag.”

### FIELD OF THE INVENTION

The invention relates generally to a protective enclosure for electronic devices, for example, optical devices such as cameras.

### BACKGROUND OF THE INVENTION

Protection of equipment is of critical importance to photographers, and even more so for photographers who work in extreme environmental conditions. The invention relates to an enclosure that provides protection from several sources: environmental hazards (e.g. rain, sand, or dirt), user abuse (e.g. scratching or excessive physical shock or vibration), and wear from excessive usage. Protection from these hazards is a high priority to a photographer working in these environmental conditions.

Cameras are available in varying complexities. Some are relatively simple requiring only a few user interface points. Others are quite complex, requiring user access to buttons and doors on almost every face of the camera. In addition, some cameras contain extending integrated flashes, interchangeable lenses, multiple LCDs and viewports. The invention described addresses complex cameras, such as digital single lens reflex (DSLR) cameras. Simpler cameras may be addressed with the same invention with a corresponding simplification of the parts.

For the sake of simplicity, the invention is described in detail for usage with cameras, camera equipment and accessories. Nevertheless, the invention described herein can apply to usage with any object or device that requires protection from environmental conditions, and as such, the teaching is the same for each application.

### SUMMARY OF THE INVENTION

This invention relates to a weatherproofing and protective “armor” enclosure concept for cameras and other electronic equipment. This is an improvement to the current state-of-the-art that allows a photographer to take a camera out into the rain and other extreme conditions and access all the camera controls through the enclosure while limiting the actual camera from the environmental hazards. To the extent the enclosure described herein is capable of keeping water away from the camera, the invention can be labeled “waterproof,” but the enclosure does not protect the camera in a fully submersible environment and is not suitable for underwater operation.

On the majority of DSLR cameras on the market, the lenses are interchangeable from the camera body. This allows the user more flexibility and performance while allowing them to only purchase the lenses that they plan to utilize. To address the needs of DSLR cameras, in accordance to one embodiment of the invention, the protective enclosure has two major sub-systems: a lens enclosure and a body enclosure. It is contemplated within the scope of the invention that each sub-system can be used individually or in conjunction to provide complete protection of the DSLR camera.

In accordance with one embodiment of the invention, the protective enclosure features a customized hard or semi-hard front and rear shells for the camera body rotatably connected at a hinge. The front and rear shell are customized for each individual make and model of camera. The two components are attached at one end by the hinge and secured at the other end by a latch. An elastomeric skin, which can cover some or all of the camera body, serves as a gasket between the front and rear shells. In accordance with one embodiment of the invention, the elastomeric skin can be replaced with a gasket carried on one or other of the two shells that seals the case when closed.

In accordance with one embodiment of the invention, the elastomeric skin is exposed in areas that the shell components do not cover. These exposed areas allow the user access to functional areas on the camera, buttons, switches or dials. In accordance with one embodiment of the invention, the elastomeric skin replicates the existing camera buttons with elastomeric/rubber buttons, loose fitting dome areas for rotating parts, e.g. knobs and scroll wheels, which the user can press, squeeze, rotate, squeeze and rotate, or press and rotate to activate all the existing functions of the camera, without exposing the controls to any dirt or moisture.

In another embodiment of the invention the rotating controls are accessed via geared and individually sealed knob subassemblies carried on one or the other of the two shells.

In all embodiments, the shell parts are opened by disengaging a draw down latch or other gasket compressing mechanism and swinging open one shell relative to the other. Opening the shells gives the photographer access to out of the field functions e.g. battery compartments, memory card compartments and digital photo transmission cabling connector ports.

### BRIEF DESCRIPTION OF THE DRAWINGS

The drawings illustrate the design and utility of embodiments of the invention, in which similar elements are referred to by common reference numerals and in which:

FIG. 1 illustrates the various components of the protective enclosure in accordance with one embodiment of the invention.

FIG. 2 is a rear view of the body sub-system in accordance with one embodiment of the invention.

FIG. 3A-C shows different views of the body sub-system in a closed configuration in accordance with one embodiment of the invention.

FIG. 4 illustrates the lens sub-system in accordance with one embodiment of the present invention.

### DETAILED DESCRIPTION

Various embodiments of the invention are described herein with reference to the figures. It should be noted that the figures are not drawn to scale and elements of similar structures or functions are represented by like reference numerals throughout the figures. It should also be noted that the figures are only intended to facilitate the description of specific embodiments of the invention. The embodiments are not intended as an exhaustive description of the invention or as a limitation on the scope of the invention. In addition, an aspect described in conjunction with a particular embodiment of the invention is not necessarily limited to that embodiment and can be practiced in any other embodiment of the invention.

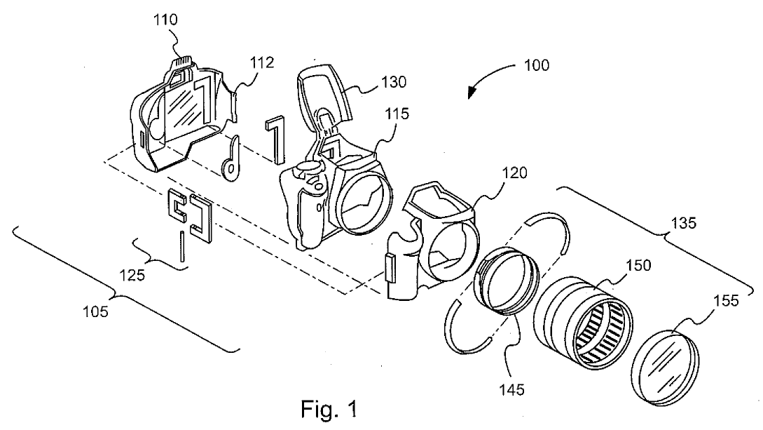

Turning to the drawings, FIG. 1 illustrates the various components of protective enclosure 100 in accordance with one embodiment of the invention.

Body Sub-System 105

The camera body (not shown) and lens (not shown) should be inserted into protective enclosure 100. Protective enclosure 100 is then closed to maximize the environmental protection. In accordance with one embodiment of the invention, protective enclosure 100 features body sub-system 105 to accomplish this task. Body sub-system 105 includes a hard or semi-hard rear shell 110 that is rotatably connected to a hard or semi-hard front shell 120. In a preferred embodiment of the invention, rear shell 110 and front shell 120 are polycarbonate, which provide excellent durability and strength in a lightweight, transparent material. Additionally, rear shell 110 and front-shell 120 may be customized for the make and model of camera to be close fitting to the camera body for aesthetic, ergonomic and other general performance reasons.

These two pieces pivot about hinge 112 and are attached to each other by means of latch 125 or other locking and gasket compressing mechanism. Front shell 120 and rear shell 110 are sealed to each other or the camera surfaces by means of a compliant gasket 115. Gasket 115 may be attached to either front or rear shell or it may be a piece that is distinct and is installed separately. In one embodiment of the invention, gasket 115 is a elastomeric skin form fitted either a portion or portions of the camera or surrounds the entire camera.

Because gasket 115 is compliant, it can serve additional functions beyond sealing the front shell 120 and rear shell 110. The user can actuate controls through gasket 115. Not all the controls need to be accessed through the compliant gasket 115. There may be other compliant members that are integrated into either front shell 120 or rear shell 110 to actuate some of the controls. Gasket 115 may also extend through portions of the front shell 120 or rear shell 110 in order to aide the user's grip of the assembly. Another advantage of compliant gasket 115 is that it may serve as a tether between itself and a removable or semi-removable piece like a door or a lid. Still another advantage of compliant gasket 115 is that it can be used as a shock absorption member for the entire assembly when placed between front shell 120 and rear shell 110. This allows the camera to float within protective enclosure 100. If a user were to inadvertently drop the camera, the impact that the camera body experiences, and the expectant resulting damage, is reduced.

To account for an add-on flash or the use of the built-in flash of a DSLR camera, two solutions are contemplated in the present invention: removable lid 130 and expandable lid or flap 160 (not shown). Removable lid 130 can be attached to any of the body sub-system components, with rear shell 110, gasket 115, or front shell 120. Ports and doors for other compartments, including but not limited to the battery or memory card, are designed in a similar fashion, preferably attached via a hinged lid or hatch to any of the body sub-system components. For the expandable lid/flap, elastomeric gasket 115 is molded and slit to provide an enlarged opening for a built-in pop-up flash. Each solution is further discussed in detail below.

Portions or all of front shell 120 or rear shell 110 may be transparent. This advantageously aids a user in seeing through the shell to icons, screens, or viewfinders on the camera.

Additionally, there may be a mount plate (not shown) attached to the bottom of the body sub-system. The mount allows the entire assembly to be rigidly mounted to a tripod. This is especially useful for a user wishing to set up the camera on a tripod in an outdoor setting where weather or other environmental conditions might be too harsh to leave the camera unprotected for any length of time. The mount may also be equipped with side ‘wings’ that allow for capture to quick release harness, holsters, or the like.

Furthermore the tripod mount plate has three anchor point through holes that allow for secure attachment of a standard or custom two point camera strap, that because of the location of the tripod mount plate causes the camera to hang lens down in a natural more stable arrangement than with standard strap anchor locations and especially by using the third point with a secondary strap, loop, or loop clip assembly causes the camera to be held securely close to the photographers' body, hips or chest.

Lens Sub-System 135

A typical lens (not shown) may have multiple rotating rings, multiple protrusions, and multiple user actuated switches or other controls. In accordance with one embodiment of the invention, lens enclosure 150 attaches to body sub-system 105 and does not rely on attaching to the lens itself. This allows for a variety of different manufacturer's lenses to be compatible with a single lens enclosure 150, provided that the lenses were all below a defined dimensional size (i.e. smaller than lens enclosure 150). For additional protection to the lens, lens enclosure is closed on the distal end by a transparent medium, lens cover 155, which allows the camera lens to view through. In order for the user to rotate one or more of the rings on the lens, a portion or all of the body of lens enclosure 150 is compliant, preferably manufactured from an elastomeric material. This allows the user to deflect lens enclosure 150, thereby grabbing onto the lens adjustment ring. If lens enclosure 150 is fixed to the body sub-system 105, the user can only rotate the adjustment ring a short angular distance. The user then releases the grip on the adjustment ring and allows lens enclosure 150 to return to its original shape. The user can then squeeze lens enclosure 150 again, thereby moving the adjustment ring in incremental steps. In accordance with another embodiment of the invention, lens enclosure 150 is attached to the lens itself, and may be angularly rotated. Utilizing lens adjustment band 145, affixed to the lens itself, the user can rotate the adjustment ring once to the final desired position.

In accordance with another embodiment of the invention, lens enclosure 150 affixed to the distal portion of the lens. Many lenses have threaded grooves for lens filters and other accessories on the distal end of the lens allowing for the described attachment. Advantageously, this configuration allows for a fixed axial relationship between the distal ends of both the lens and the lens enclosure 150. This would allow for wide angle lenses to be used without the problem of angular field of view vignetting. In accordance with one embodiment of the invention, lens enclosure 150 would utilize transparent lens cover 155 at the distal end of the lens as described above. Sealing at the proximal end could occur with a sliding contact between lens enclosure 150 and body sub-system 105. In less severe environments, complete sealing might not be absolutely necessary. In such conditions, there may not need to be a seal at the proximal end. A simple overhang or overlap may be adequate to shed rain or other contaminants.

Switches and buttons on the lens may be actuated by the user through the compliant lens enclosure 150 itself, as described above for complaint gasket 115. Alternatively, a part specifically dedicated to that purpose may designed with an opening or actuator to accommodate physical access to switches and buttons on the lens as desired. In accordance with one embodiment of the invention, for lenses that do not feature complete sealing at the proximal end, the user may simply reach around the lens enclosure to actuate the switch directly.

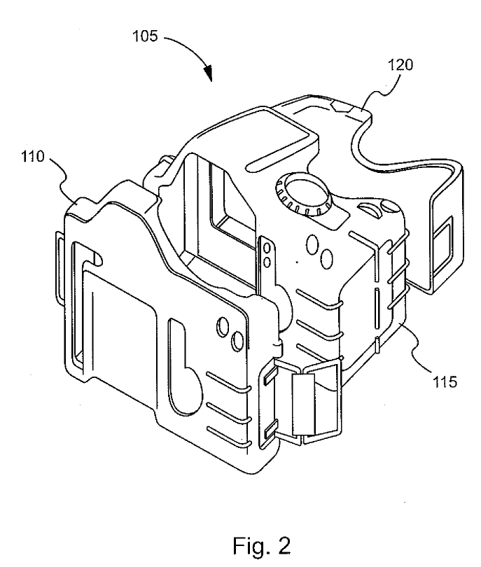

FIG. 2 is a rear view of body sub-system 105 with components rear shell 110, elastomeric gasket 115, and front shell 120 in accordance with one embodiment of the invention. Body sub-system 105 also features hinge 112 at one end and latch 125 at an opposing end to secure body sub-system 105 around a camera. However, any number of securing mechanism well known in the art may be utilized, including but not limited to multiple latches, locks, clips, and screws. As shown, gasket 115 features expandable lid 160 for access and use of a built-in pop-up flash in accordance with one embodiment of the invention.

As shown in FIG. 2, the protective enclosure of body sub-system 105 features a variety of methods for access and actuation of buttons switches and dials. Typically, there are three major types of actuators on the surface of a camera: buttons, sliders and knobs. Buttons are switches that are actuated by pushing normal to the surface of the camera for a short distance. In accordance to one embodiment of the invention, button are actuated through protective enclosure 100 using a compliant member affixed to either rear shell 110, gasket 115, or front shell 120. The user pushes the compliant member in the same direction. Sliders are switches that move parallel to the surface of the camera. Sliders may also be dials or wheels that rotate about an axis parallel to the surface of the camera. In either case, the user is required to move a portion of the switch some distance along the surface of the camera to actuate. In accordance to one embodiment of the invention, the compliant member over the slider is elastomeric and thin, allowing the user to use a fingernail to push against the elastomeric material and engage the slider. The user moves the slider by allowing the fingernail to slip with respect to the elastomer. Another camera actuator to interface with is the knob. Knobs rotate about an axis essentially perpendicular to the surface of the camera. In some instances, depending on the camera model, knobs only move between two rotational positions. Others may have detents, and still other knobs may rotate continuously in either direction. In accordance to one embodiment of the invention, a precisely molded elastomer is be placed over the knobs providing a tight fir around the knob. The elastomer may also contain extra material that can deform and translate in order for the user to actuate the knob. For example, the inside layer of elastomer in contact with the knob has a material that sticks to other material very well, for a better grip and better rotational ability.

In accordance with another embodiment of the invention, the actuators can be protected and accessed via a removable lid, hinged lid, expandable lid or flap that covers the actuator until a user needs access to it. This allows the user to temporarily open a port and thereby attain direct access to the actuator.

In accordance with another embodiment of the invention, sliders and knobs are covered with a specifically designed part not affixed to rear shell 110, gasket 115, or front shell 120. This part interfaces directly with the actuator and allows the user access to the actuator while still protected. The part may sit under an open or exposed port of rear shell 110, gasket 115, or front shell 120. In effect, the actuator has its own protective enclosure, used in conjunction with protective enclosure 100.

As shown in FIG. 2, gasket 115 features accessible media holes and etc. Secondary plugs and covers may be optionally added for more complete weatherproofing. Plug seals may be utilized to close off the openings against the water, dust, dirt, scratches and other hazards. Plug seals may be made of rubber, elastomeric material, hard plastic, polycarbonates, or any other material that provides the desired functionality and aesthetics.

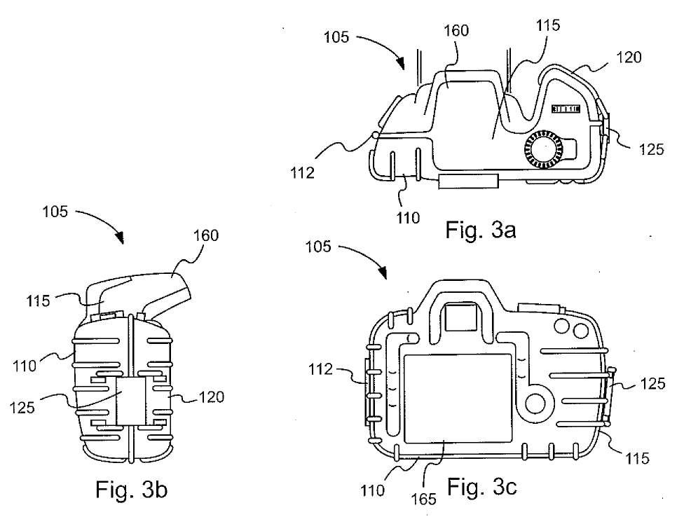

FIG. 3A-C shows different views of the body sub-system 105 in a closed configuration in accordance with one embodiment of the invention. Protective enclosure of body sub-system 105 features rear shell 110, elastomeric gasket 115, front shell 120, hinge 112, latch 125 and expandable lid 160 in accordance with one embodiment of the invention. Body sub-system 105 also features hinge 112 at one end and latch 125 at an opposing end to secure body subsystem 105 around a camera.

In accordance to one embodiment of the invention, expandable lid 160 is featured for use with a pop-up flash or other extending portion of the camera. However, other designs contemplated within the scope of the invention may be used. For example, expandable lid 160 may be replaced with removable lid 130 (not shown in FIG. 3), and can be attached to any of the body sub-system components, affixed to rear shell 110, gasket 115, or front shell 120. These features are discussed in detail below.

With modern DSLR cameras, most have flashes that the user deploys to a position distinct from the camera body. These represent an issue for a protective case as they momentarily make the camera larger.

There are two other classes of solutions contemplated in the present invention: removable lids and expandable lid/flap solutions. In accordance with one embodiment of the invention, a removable lid that is temporarily removed from the stowed position. This may or may not be tethered to the camera via a hinge or other tethering mechanism. The edge of the lid which would snap down to the enclosure could also be attached with a zippered or other latching method.

In accordance with one embodiment of the invention, an expandable lid or flap is made of elastomeric material that is molded in an expanded state. Since it is fabricated in an expanded condition, it has a preference to remain in that state. Additional external means can be used such as clips or latches to hold the expandable lid collapsed. When the clip or latch is removed, the flash cover expands.

In accordance with one embodiment of the invention, the expandable lid 160 and removable lid 130 described may feature a transparent or translucent window that allows the flash to shine through. In less severe environmental conditions, this could be completely open.

As shown in FIG. 3C, many digital cameras have LCDs which allow the user to instantly view pictures that they have just taken. The LCD is one of the most fragile and damage prone pieces of the camera. To protect the camera's LCD, the illustration shows a clear hard plastic LCD cover 165 which covers the fragile LCD. Rear shell 110 or gasket 115 is designed to hold LCD cover 165 on the camera and prevent it from falling-off. LCD cover 165 can also be coated in various finishes to provide different functional benefits. These include, but are not limited to, antiglare coating, privacy screen, and magnification for easier viewing of pictures taken.

Another coating could be on the perimeter of the elastomeric material, so that LCD cover 165 is separated from the LCD by a small distance, to avoid scratching and also prevent the LCD cover 165 from sliding around. There are often buttons and other controls in close proximity to the LCD. LCD cover 165 may feature holes in position over the existing buttons on the camera. An elastomeric skin can be utilized with LCD cover 165 to cover the holes. The skin protrudes through LCD cover 165 and allows the user to press on the skin and activate the buttons through the cover.

The LCD cover or lens cover may be made of transparent, translucent, reflective, clear, semi-clear material, or other material with the desired properties. In accordance with one embodiment of the invention, the cover is a film which sticks to the surfaces by static force (or low adhesive surface or “vinyl magnet”).

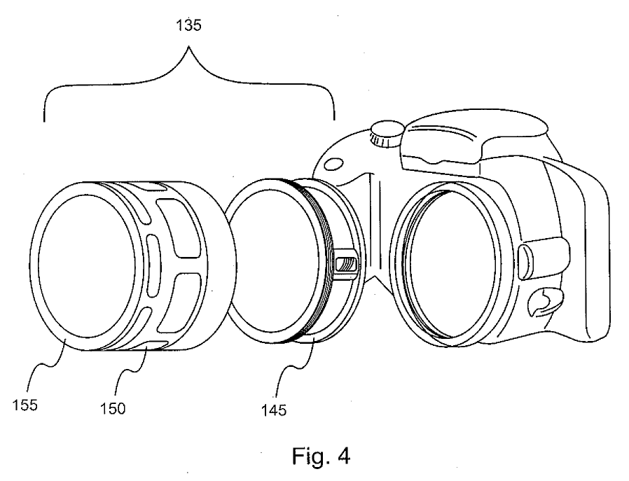

FIG. 4 illustrates lens sub-system 135 in accordance with one embodiment of the present invention. As shown, lens sub-system 135 features lens enclosure 150, lens adjustment band 145, and lens cover 155. As shown in FIG. 4, in accordance with one embodiment of the invention, lens enclosure 150 and lens cover 150 are attached to the distal portion of the lens. Lens cover 155 is affixed via threading on the lens filter attachment (not shown), and may be an off the shelf lens filter. As lens enclosure 150 is attached to the lens itself and axially fixed. This creates a fixed axial relationship between the distal ends of both the lens and the lens enclosure 150, and thereby allows the user to angularly rotate the lens adjustment ring without effecting lens enclosure 150.

Additional protection is provided by utilizing lens adjustment band 145, affixed to the lens itself, for example around any of the lens' adjustment rings. Once attached to an adjustment ring, adjustment band 145 provides greatly enhanced protection from environmental conditions, but provides full functionality and performs of the adjustment rings.

Switches and buttons on the lens or adjustment rings may be actuated by the user through the lens enclosure 150 and adjustment band 145, for example, if lens enclosure 150 and adjustment band 145 are made of an elastomeric material. Alternatively, if lens enclosure 150 and adjustment band 145 are made of a hard or semi-hard material, these components may be designed with openings or port holes to accommodate physical access to switches and buttons on the lens as desired. As with other components of protective enclosure 100, elastomeric material applied through openings and port holes to provide an additional protective covering and access to switches on the lens and lens adjustment rings.

It is contemplated within the scope of the invention, that the components utilized by protective enclosure 100 may be made from any one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, multi-dimensional structure, folded structure, hinged plates, transparent material, translucent material, reflective material, fluorescent material, metal-plated material, painted material, rug, woven material, wooden material, insulation material, water-cooling jacket, air-cooling jacket, heating-element jacket, insulation jacket, or any similar, compound, chemical, or composite material.

What is claimed is:

1. A protective enclosure for a camera, comprising:
a polycarbonate front shell, wherein said front shell is molded from a portion of the front of said camera, and wherein said front shell has at least one hole to access controls on said front of said camera;
a polycarbonate rear shell, wherein said rear shell is molded from a portion of the back of said camera and wherein said rear shell has at least one hole to access controls on said back of said camera;
an elastomeric gasket molded to fit between said front shell and said rear shell, wherein said gasket is compressed between said front shell and said rear shell to form a waterproof barrier between said front shell and said rear shell;
a hinge affixed to a side of said front shell and said rear shell, wherein said hinge connects said front and said rear shell, and wherein said front shell and rear shell pivot about said hinge;
a latch affixed to a side of said rear shell opposite to said hinge; and
a strike affixed to a side of said front shell opposite to said hinge, wherein said latch is secured to said strike to lock said front shell to said rear shell, and wherein said latch is secured to said strike to compress said gasket between said front shell and said rear shell.

2. An enclosure for a camera, comprising:
a front shell, wherein said front shell is molded from a portion of the front of said camera;
a rear shell, wherein said rear shell is molded from a portion of the back of said camera;
a gasket, wherein said gasket is compressed between said front shell and said rear shell to form a waterproof barrier between said front shell and said rear shell;
a hinge affixed to a side of said front shell and said rear shell, wherein said hinge connects said front and said rear shell;
a latch affixed to a side of said rear shell opposite to said hinge; and
a strike affixed to a side of said front shell opposite to said hinge, wherein said latch is secured to said strike to lock said front shell to said rear shell.

3. The enclosure of claim 2, wherein said front shell is has at least one hole to access controls on said front of said camera.

4. The enclosure of claim 3, wherein said front shell is polycarbonate.

5. The enclosure of claim 2, wherein said rear shell is has at least one hole to access controls on said rear of said camera.

6. The enclosure of claim 5, wherein said rear shell is polycarbonate.

7. The enclosure of claim 2, wherein said gasket is made of an elastomer.

8. The enclosure of claim 7, wherein said gasket is molded from a portion of the front of said camera.

9. The enclosure of claim 7, wherein said gasket is molded from a portion of the back of said camera.

10. The enclosure of claim 2, wherein said front shell and rear shell pivot about said hinge to open and close around said camera.

11. The enclosure of claim 2, wherein said latch is secured to said strike to compress said gasket between said front shell and said rear shell.

12. A protective enclosure for an object, comprising:
a front shell, wherein said front shell is molded from a portion of the front of said object;
a rear shell, wherein said rear shell is molded from a portion of the back of said object;
a gasket, wherein said gasket is compressed between said front shell and said rear shell to form a waterproof barrier between said front shell and said rear shell;
a hinge affixed to a side of said front shell and said rear shell, wherein said hinge connects said front and said rear shell;
a latch affixed to a side of said rear shell opposite to said hinge; and
a strike affixed to a side of said front shell opposite to said hinge, wherein said latch is secured to said strike to lock said front shell to said rear shell.

13. The enclosure of claim 12, wherein said object is a camera.

14. The enclosure of claim 12, wherein said front shell is polycarbonate.

15. The enclosure of claim 12, wherein said rear shell is polycarbonate.

16. The enclosure of claim 12, wherein said gasket is made of an elastomeric material.

17. The enclosure of claim 16, wherein said gasket is molded from a portion of the front of said object.

18. The enclosure of claim 16, wherein said gasket is molded from a portion of the back of said object.

19. The enclosure of claim 12, wherein said front shell and rear shell pivot about said hinge to open and close around said object.

20. The enclosure of claim 12, wherein said latch is secured to said strike to compress said gasket between said front shell and said rear shell.
